(19) United States
(12) Patent Application Publication
(10) Pub. No.: US 2011/0011939 A1
(43) Pub. Date: Jan. 20, 2011

(54) CONTACT-LESS AND DUAL INTERFACE INLAYS AND METHODS FOR PRODUCING THE SAME

(76) Inventor: Linda Seah, Singapore (SG)

Correspondence Address: SCHWEGMAN, LUNDBERG & WOESSNER, P.A., P.O. BOX 2938, MINNEAPOLIS, MN, 55402, US

(21) Appl. No.: 12/747,278

(22) PCT Filed: Dec. 19, 2007
(86) PCT No.: PCT/SG07/00434

§ 371 Date: Sep. 8, 2010

(51) Int. Cl. G06K 19/067; B32B 37/14

(52) U.S. Cl. 235/492; 156/297; 156/73.1; 156/64

(57) ABSTRACT

Embodiments of the present invention provide an inlay for use in multiple applications including a contact smart card, a contactless smart card, a ticket, a secured document, a combi smart card and a dual interface smart card. The inlay may include an inlay substrate; an antenna on the inlay substrate, the antenna having at least two terminal pads; and a polymer PCB bonded to and making an electrical connection between each of the terminal pads; wherein the terminal pads and polymer PCB are positioned to allow the inlay to be used in a desired smart card application, the application selected from a group consisting of a contact smart card, a contactless smart card, a ticket, a secured document, a combi smart card and a dual interface smart card; wherein, when the inlay is to be used in a contactless smart card, ticket, secured document or combi smart card, the polymer PCB functions as a carrier for a chip; and wherein, when the inlay is to be used in a dual interface or contact smart card, end portions of the polymer PCB function as strap leads to connect an embedded chip of the dual interface or contactless smart card to the antenna. One method for producing the inlays is also disclosed.

### FIELD OF INVENTION

Embodiments of the present invention relate to the field of smart cards, and particularly to a design and method of production for contact-less and dual interface inlays for use in smart cards.

### BACKGROUND

Smart Cards, also known as Chip Cards and IC Cards, are plastic (usually), approximately credit card sized cards that contain one or more semiconductor chips. Smart cards can be used in many different applications. For example, smart cards can be used in the telecommunications industry for mobile SIM and prepaid cards. They can be used in the banking industry for e-payments and transaction & authentication applications. They can be used in the security industry in applications ranging from access control to passports, National IDs, and/or Drivers licenses. They can also be used in logistic industry for object identification and traceability. In many of these applications, the cards are “contactless”, which means that the cards perform data transfer using radio frequency (RF) technology between the card and a receiver/transmitter. In other applications, the cards can be “contact” cards that require a physical connection between the card and the card reader. Additionally, “dual interface” cards can have both capabilities using a single chip module. Similarly, combination cards (combi cards) can perform both capabilities using one chip for contactless applications, and a separate chip for contact applications.

Currently, these cards can be manufactured using a number of different processes. In most of these, the chips are wire bonded between a plurality of integrated circuit (IC) bond pads onto epoxy carrier tapes. They can then be either encapsulated using a glob top method with an ultraviolet (UV) curing epoxy, or moulded using a pre-formed cavity into the desired shape and thickness to become various types of modules. The most popular IC modules for phone cards and banking cards are either M4 or M8 module packages. These packages physically and electrically comply with various International Standards Organization (ISO) standards, such as ANSI/ISO/IEC 7816/7810.

Today, contact-less cards are produced in relatively smaller quantities of approximately 100-200 million in 2006, which is about 10% of the current volume of smart cards produced. The most common method of manufacturing contact-less products uses a process of connecting the chip module to a wire antenna pre-embedded into polyvinyl chloride (PVC) plastic. Normally, the blank card with antenna is manufactured by assembling the electronic inlay (chip+antenna+support) with additional layers laminated onto the electronic inlay to build up the card thickness, for example, the ISO 14443 and ISO 7816 ID-1 standards. The cards are often manufactured in sheets, being, for example, several cards wide and of varying length. Alternative chip bonding technology, such as flip chip bonding, is gaining popularity for use on top of the wire bonding technology as the use of chip scale packaging increases.

Dual interface cards are derivatives of Contact and Contact-less cards. After lamination, the sheets are punched into single cards and then the cavity for the chip module is milled. An additional step must then be taken to “ply open” the antenna cavities below the shoulder of the first milled cavity to provide access to the antenna contacts. Since the lamination process of applying top sheets covers up the antenna, the antenna terminals can only be accessed using some milling process. A conductive adhesive can then be placed into the milled cavities to provide an electrical contact between the antenna leads and the contact surfaces on the chip module. The conductive adhesive may be, for example, a nickel-polymer particle filled epoxy paste. The chip is thereby electrically connected to the antenna.

Additionally, nonconductive adhesive can be applied to the shoulder of the milled out cavity in order to mechanically secure the chip module to the smart card body. The separate nonconductive adhesive is used to hold the chip module within the card body as it is less expensive and has better adhesive qualities than conductive adhesive.

Liquids adhesives, such as a Cyanoacrylate adhesive, are generally used as the nonconductive adhesive in less expensive smart cards. In more critical smart card applications, a double-sided, heat-curable, adhesive tape can be used. Normally, this double-sided, heat-curable non-conductive adhesive is first applied to the inner side of the chip module with a hot-press. Then the chip module is inserted into the cavity and bonded to the card body with the applied non-conductive adhesive by heat and pressure.

Problems with Current Cards

1) Contactless Cards

Due to limitations in the speed of the ultrasonic wire embedding process, the output volume using wire antenna embedding is fairly low, which keeps the costs associated with the production of such cards using the wire embedding process relatively high.

2.) Dual Interface Cards

Reliably attaching the chip module to the antenna leads can be difficult. For example, even though the connections between the modules and the antenna leads can be accomplished using conductive adhesives, thermo-compression bonding, or a low temperature soldering material, less than 80% of dual interface cards produced according to the prior art method are functional, i.e., more than two in ten are defective.

Additionally, multiple layers of plastic sheeting are added to the inlays during production to bring the dual interface cards to a required thickness. During the hot lamination process, the unpredictable shrinkage in the various layers of plastic sheeting can drastically reduce the reliability of the connection between the dual interface module and the antenna.

3) Antennas

It is also known in the industry that alternative antennas can be made using laminated aluminium etched on plastic film such as PVC or PET, to produce contactless cards. The use of such etched antennas has generally been said to produce cards with poorer read distance (supposedly lower Quality factor or Q factor). The conventional wisdom is that etched aluminium antennas cannot provide the electrical performance, such as a read distance of 10 cm (min) and 20 cm (max) typical of systems using the High frequency ISO 14443 Mifare chip; nor the 60 cm (min) to 100 cm (max) typical of systems using the High Frequency ISO 15693 Icode SL2 chip. For these reasons, there has been no major development work in using etched antennas to make ISO cards.

Additionally, antennas made from etched aluminium always have an open loop. To close this loop, it is necessary to provide a cross-over connection between the outer portion of the antenna and the inner portion of the antenna. Closing this loop often requires additional production steps when forming a completed antenna inlay.

Another problem associated with aluminium antennas is the amount of stress added to the etched antenna as the various types of cards are laminated under high heat and pressure. Consequently, such cards are thought to be incapable of achieving satisfactory results on ISO industry standard tests. For example, for long term durability (greater than 5 years use), the capability of performing up to 20,000 cycles in the ISO-10373 bending and torsion test is the de facto industry standard (ISO 10373 stipulates 1000 cycles for normal card usage).

Micro modules for contact less and dual interface cards have traditionally been supplied in the form of MOA2, MOA4, MOB6, FCP2, MCC2, MCC8, M8.4, D7, D8, CID pak etc. modules. The antenna routing and antenna terminal pad location for contactless and dual interface cards has traditionally been different for different module dimensional outlines and chip systems. The terminal locations for the antenna in one module (such as MOA2) are in a different location from the terminal locations of another module (such as FCP2). This result in inefficiencies in producing inlays for different applications, as a different automation system and/or setup is required to produce the inlays.

The capability to quickly and efficiently automate the production process is a key in keeping production costs down. Being able to produce antenna inlays in roll form with greater flexibility in handling the micro modules is the stepping stone to automation, particularly when one antenna has to cater for a wide variety of standards, namely the ISO cards, Calypso tickets, and non-ISO such as ICAO 9303 part-1 recommendation for secure documents. Current production methods are unable to achieve this functionality.

Accordingly, there is a significant need for an improved manufacturing process that can attach the components of smart cards, while addressing one or more of the problems discussed above.

### SUMMARY

Embodiments of the present invention provide a new method to attach a polymer PCB to an antenna structure to produce an inlay for use in both contactless and dual interface cards, tickets and secure documents. The method provides a thin polymer PCB that is ultrasonically bonded to the two ends of the antenna terminal pads. This polymer PCB may or may not have a chip bonded to it. In example embodiments, the polymer PCB is placed and connected at the exact position designated by the ISO 7816 standard for contact and dual interface modules. The polymer PCB can be a double layer PCB that has specific dimensional tolerances. In some embodiments, the polymer PCB includes metal surfaces to effect an electrical connection between the module contact surface and the antenna pads using ultrasonic bonding techniques. To solve these connection problems, one may attach a copper or aluminium strip (polymer PCB) to an etched aluminum antenna having two bond pads positioned according to the ISO 7816 dimensional standard. Additionally, by ensuring that the bond pad positions are also located such that they exactly match the positions required for contact module attachment, it is possible to mill away the unwanted portion of the polymer PCB to leave behind 2 connecting surfaces. These surfaces (vertical bridges) can be used to directly connect the antenna to the contact pad of the dual interface chip module to produce dual interface inlays. The same concept, without the milling step, can deploy the polymer PCB as an umbilical cord (horizontal bridges) to carry chips in making contact-less inlays. In addition, by sandwiching the antenna layer with low vicat softening plastic sheets, the distortion and mechanical stress impact on the etched aluminum antenna is substantially reduced and the antenna can withstand higher bending and torsion cycles.

One aspect of the present invention provides an inlay for a smart card, the inlay including an inlay substrate; an antenna on the inlay substrate, the antenna having at least two terminal pads; and a polymer PCB bonded to and making an electrical connection between each of the terminal pads; wherein the terminal pads and polymer PCB are positioned to allow the inlay to be used in a desired smart card application, the application selected from a group consisting of a contact smart card, a contactless smart card, a ticket, a secured document, a combi smart card and a dual interface smart card; wherein, when the inlay is to be used in a contactless smart card, ticket, secured document or combi smart card, the polymer PCB functions as a carrier for a chip; and wherein, when the inlay is to be used in a dual interface or contact smart card, end portions of the polymer PCB function as strap leads to connect an embedded chip of the dual interface or contactless smart card to the antenna.

The polymer PCB may be a substrate having a layer of aluminum or copper foil attached to each of a top side and a bottom side of the substrate, wherein the chip is electrically coupled to the layer of aluminum or copper foil on one of said top side and the bottom side and the terminal pads, for use in the contactless smart card, said ticket, said secured document, or said combi smart card, and wherein the layer of aluminum foil provides the electrical connection between the terminal pads and the chip or a chip module.

In some embodiments, the chip may be a micromodule selected from a group consisting of MOA2, MOA4, MOB4, MOB6, MCC2, MCC8, CID, Cubit, IOA2, EOA2, EOA8, EOA9, FCP3 and NSL-1 micromodules. The terminal pads may be at least 0.25 square millimeters in area. The polymer PCB may include a substrate having a layer of aluminum or copper foil attached to each of a top side and a bottom side of the substrate for use in producing the dual interface and the contact smart cards, the antenna comprises three terminal pads, and the layers of aluminum or copper foil provide the electrical connection between the terminal pads and a dual interface module.

The inlay may be sandwiched between a plurality of laminated sheets to produce a blank of the dual interface smart card. A portion of the plurality of the laminated sheets and the polymer PCB may be milled away to produce a cavity, such that a remaining portion of the polymer PCB provides the strap leads that function as a tower bridge for electrically connecting the dual interface module to the antenna to produce the smart card.

In some embodiments, the dual interface module may further include a pair of windows to facilitate bonding of the dual interface module to the strap leads.

The antenna pads and the polymer PCB may be positioned according to an industry standard selected from a group that includes an ISO 7816/7810 ID-1, ID-2, and ID-3 standard, an ISO 15457 TFC.1 standard, a Calypso standard for transportation tickets, and an ICAO 9303 Part-1 recommendation. The antenna may be made from etched aluminum having a thickness of about 9 microns to about 35 microns; a track width of about 100 microns to about 1200 microns, and a gap width of about 100 microns to about 1200 microns.

In some embodiments, the polymer PCB may be bonded to the at least two terminal pads of the antenna using an ultrasonic bonding process. The ultrasonic bonding process may use a horn having at least two pads with a pad size of about 0.25 mm by 0.25 mm, a spacing distance of about 0.5 mm, and a pitch angle of about 90 degrees.

In some embodiments, the inlay may also include at least one upper layer of low vicat plastic.

An alternate aspect of the present invention provides a method of producing an inlay for a smart card. The method may include the steps of providing an inlay substrate having an antenna thereon, the antenna having at least two terminal pads; providing a polymer PCB capable of making an electrical connection between the at least two terminal pads; and bonding the polymer PCB to each of the terminal pads; wherein the terminal pads and polymer PCB are positioned to allow the inlay to be used in a desired smart card application, the application selected from a group consisting of a contact smart card, a ticket, a secured document, a contactless smart card, a combi smart card, and a dual interface smart card.

In some embodiments of the method, the polymer PCB may include a substrate having a layer of aluminum or copper foil attached to each of a top side and a bottom side of the substrate, wherein a chip is electrically coupled to the layer of aluminum or copper foil on one of the top side and the bottom side and the terminal pads, such that the ultrasonic bonding step provides an electrical connection between the antenna and the chip for use in the contactless smart card, the ticket, the secured document, or the combi smart card.

The chip may be a micromodule selected from a group consisting of MOA2, MOA4, MOB4, MOB6, MCC2, MCC8, CID, Cubit, IOA2, EOA2, EOA8, EOA9, FCP3 and NSL-1 micromodules. The terminal pads may be at least 0.25 square millimeters in area.

In some embodiments, the method may further include applying at least one upper layer of low vicat plastic to a top of the inlay, and applying at least one lower layer of low vicat plastic to a bottom of the inlay. The polymer PCB may include a substrate having a layer of aluminum or copper foil attached to each of a top side and a bottom side of the substrate for use in producing the dual interface and the contact smart cards.

In some embodiments, the method may further include laminating at least a first layer of material to a top surface of the inlay; laminating at least a second layer of material to a bottom surface of the inlay, the first layer, the second layer and the inlay comprising a blank for producing a dual interface smart card; and milling a portion of the first layer and the inlay to remove a portion of the polymer PCB to produce a tower bridge, and to provide a cavity for receiving a dual interface module.

The method may further include connecting the dual interface module to the blank to produce the dual interface smart card. The connecting step may include; ultrasonically bonding the dual interface module to the tower bridge to provide an electrical connection to the antenna, and fixing the dual interface module to the blank using a non-conducting adhesive.

The ultrasonic bonding process may use a horn having a pad size of about 0.25 mm by 0.25 mm, a spacing distance of about 0.5 mm, and a pitch angle of about 90 degrees. The dual interface module may further include a pair of windows in a top surface thereof. The windows may facilitate the ultrasonic bonding process, a soft laser bonding process, a thermo-compression bonding process, or a micro-welder bonding process.

In alternate embodiments, the two providing steps may further include positioning the antenna pads and the polymer PCB according to an industry standard, the industry standard selected from a group consisting of an ISO 7816/7810 ID-1, ID-2, and ID-3 standard, an ISO 15457 TFC.1 standard, a Calypso standard for transportation tickets, and an ICAO 9393 Part-1 recommendation. The polymer PCB may be bonded to the terminal pads using an ultrasonic bonding process.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 illustrates a top view of an of an antenna singlet used to produce an inlay according to one embodiment of the present invention;

FIG. 2a illustrates a top view of a polymer PCB that can be attached to the antenna on the antenna singlet of FIG. 1 to produce an inlay according to one embodiment of the present invention;

FIG. 2b illustrates a bottom view of the polymer PCB of FIG. 2a;

FIG. 3a illustrates a cross-sectional view of the antenna singlet of FIG. 1, a polymer PCB of FIGS. 2a and 2b, and a portion of an ultrasonic bonding machine that can be used to join the two according to one embodiment of the present invention;

FIG. 3b illustrates a cross-sectional view of the inlay produced from FIG. 3a according to one embodiment of the present invention;

FIG. 3c illustrates one embodiment of a method for producing the inlay of FIGS. 3b and 5a;

FIG. 3d illustrates one embodiment of an ultrasonic horn shown in FIG. 3a;

FIG. 3e illustrates a top perspective view of the antenna inlay of FIG. 3b;

FIG. 4a illustrates a top view of a polymer PCB that can be attached to the antenna on the antenna singlet of FIG. 1 to produce an inlay according to an alternate embodiment of the present invention;

FIG. 4b illustrates a bottom view of the polymer PCB of FIG. 4a;

FIG. 5a illustrates a top perspective view of an antenna inlay according to an alternate embodiment of the present invention;

FIG. 5b illustrates a production sheet of the antenna inlays of FIG. 5a according to the ID-1 standard;

FIG. 5c illustrates a production sheet of the antenna inlays of FIG. 5a according to the ID-2 standard;

FIG. 5d illustrates a production sheet of the antenna inlays of FIG. 5a according to the ID-3 standard;

FIG. 5e illustrates one embodiment of a pre-laminated inlay of FIG. 3d;

FIG. 6 illustrates an exploded perspective view of one embodiment of a dual interface card that can be produced using the inlays of FIGS. 5a and 5b;

FIG. 7a illustrates an exploded perspective view of a dual interface module that can be used with the dual interface card of FIG. 6;

FIG. 7b illustrates a top view of the dual interface module of FIG. 7a;

FIG. 7c illustrates a bottom view of the dual interface module of FIG. 7a;

FIG. 8a illustrates a cross-sectional view of one embodiment of a laminated dual interface card of FIG. 6 and a dual interface module of FIGS. 7a-7c prior to assembly;

FIG. 8b illustrates a cross-sectional view of the laminated dual interface card and dual interface module of FIG. 8a after preparation of the dual interface card; and

FIG. 8c illustrates a cross-sectional view of one embodiment of an assembled dual interface card of the present invention.

### DETAILED DESCRIPTION

Embodiments of the present invention provide a new design for a smart card inlay that can be used in both contactless or dual interface applications, and methods to produce the same. These cards are produced according to various industry standards. Within this specification, the term “card” or “smart card” includes cards, electronic visa stickers, passports, tickets, labels, identification tags, anti-counterfeit tags and other secure documents.

The standards may include Form Factor standards, interoperability/modulation characteristic standards, security standards, and or testing standards. For example, the Form Factor standards may include the ISO 7816/7810 (ID-1, ID-2, ID-3) size, and the ISO 15457 TFC.1 size. Interoperability/modulation characteristic standards may include ISO 14443 and ISO 15693 (13.56 MHz), ISO 18000 (860-965 MHz), UHF and EPC compliant RIFD standards. Security standards may include EAL1+ and EAL4+ Operating System platforms, EAL5+ certified chips, and ICAO recommendations. Testing standards may include ISO 10373 and FIPS 201. It is understood that additional standards may be used to produce embodiments of the present invention. Similarly, non-standard cards may also be produced.

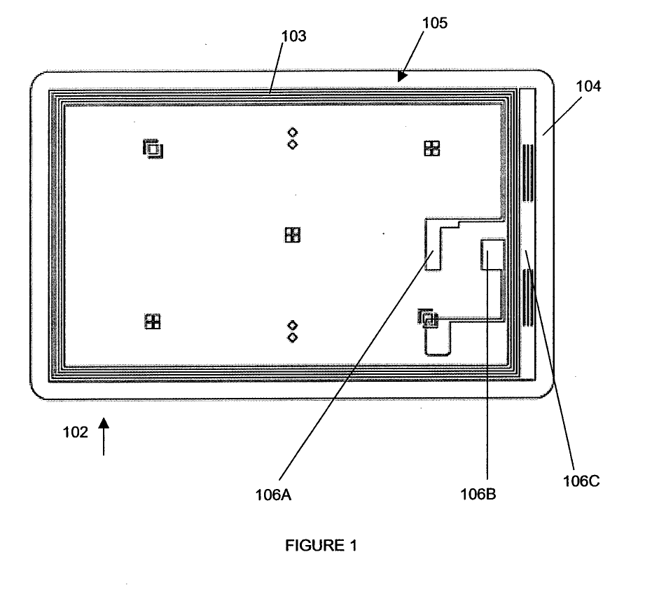

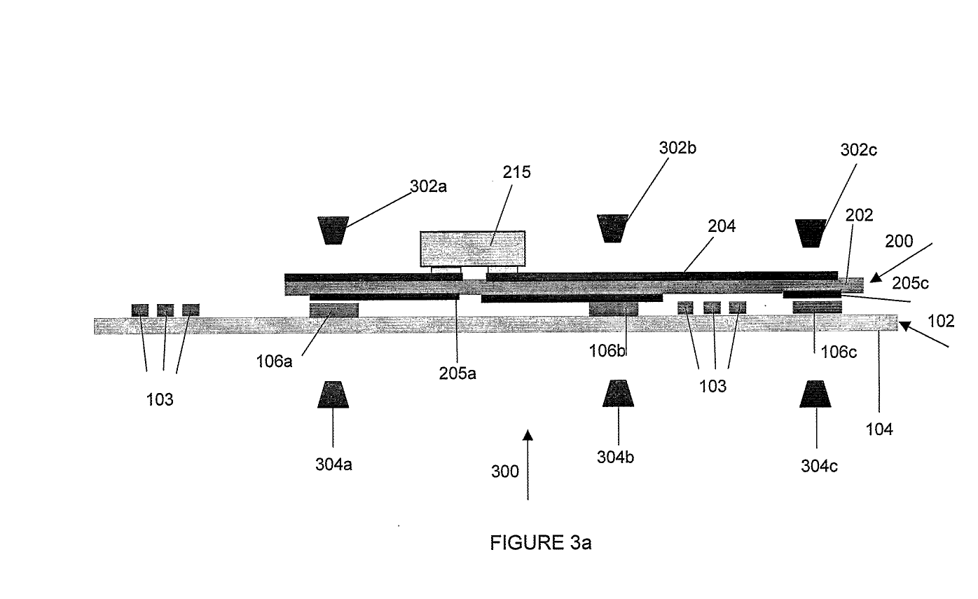

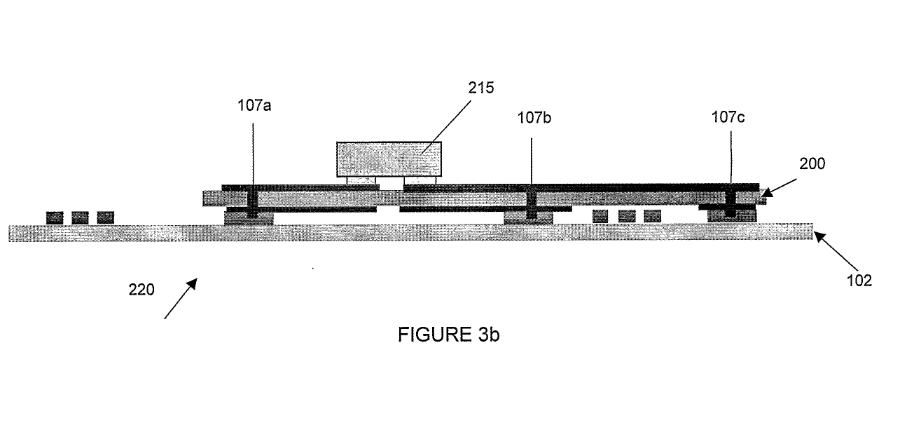

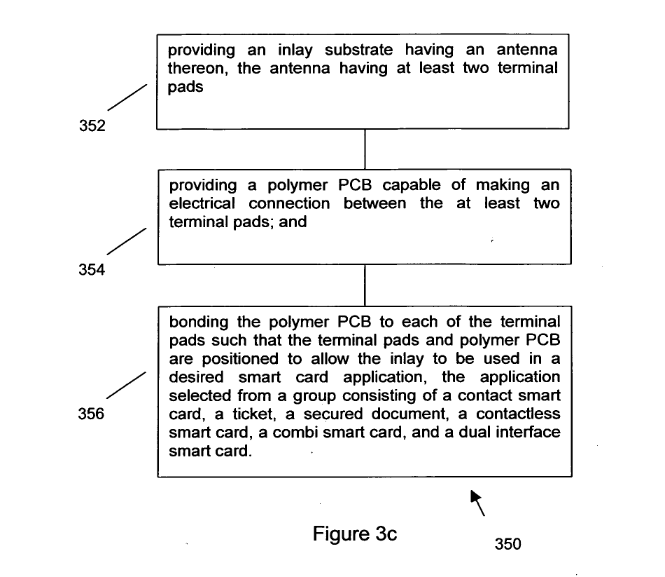

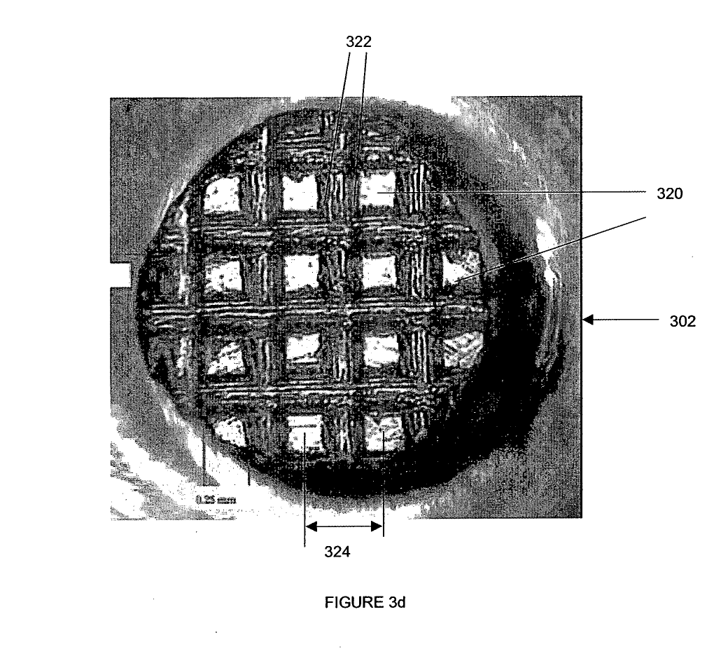

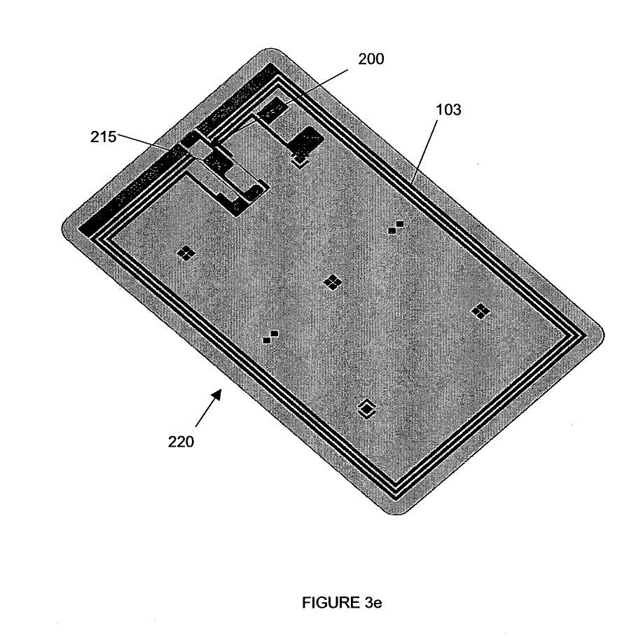

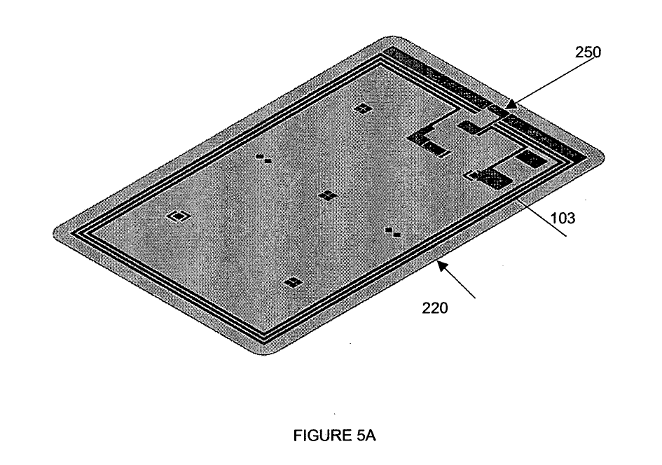

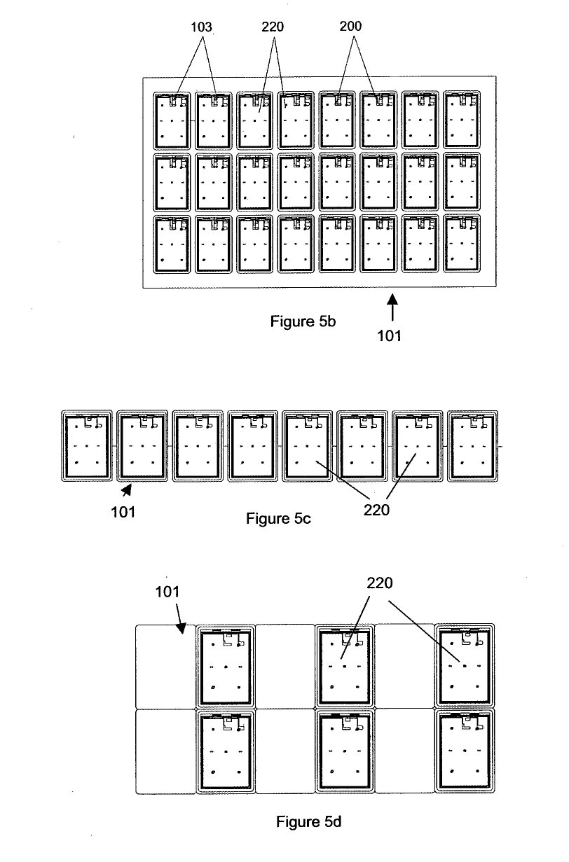

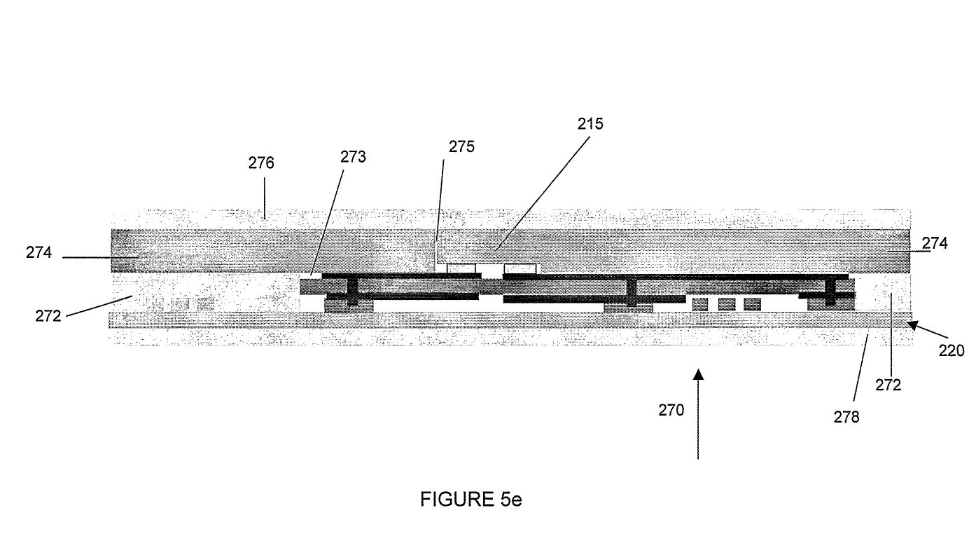

FIG. 1 illustrates a top view of an antenna singlet 102 used to produce an inlay 220 (see FIGS. 3e, 5a) according to one embodiment of the present invention. Each antenna singlet 102 can have an antenna 103 etched onto a top side 105 of a plastic sheet 104. Each antenna 103 may have two or more terminal pads 106a, 106b. These terminal pads 106a, 106b, are precisely positioned to facilitate the connection of a polymer PCB to produce a dual interface or contact-less inlay 220 that can be used in ISO 7816 standard ID-1, ID-2, and ID-3 smart cards, and ISO 15457 TFC.1 tickets. In the embodiment shown, an additional terminal pad 106c is provided on the top side 105 to facilitate an electrical connection between the ends of the antenna 103. This provides a single step process to connect the open ends of the contactless antenna 103 to the polymer PCB 200. Alternate embodiments may provide a bridge (not shown) on an underside of the antenna singlet 102. The bridge may be positioned to provide a through connection to the top side 105 to provide a continuous circuit for the antenna 103. In a preferred embodiment, the etched antenna 103 is made from aluminium. It is understood, however, that other metals, such as copper, may also be used to produce the etched antenna 103. All references below to an etched aluminium antenna 103 are considered to also include other metals.

The ID-1, ID-2 and ID-3 cards and ISO 15457 TFC.1 tickets may all use a similar antenna design concept using IC chip systems. Such systems may include, by way of example and not limitation, ISO 14443 Type A, ISO 14443 Type B, ISO 15693 or ISO 18000-6 chips. However, each of these standards defines cards of different dimensions depending on the application. For example, the ID-1 standard can be used to create National ID cards, the ID-2 standard can be used to create Visa stickers, and the ID-3 standard can be used to create passports (see e.g. FIGS. 5b-5d). TFC.1 tickets can be used to create tele-ticketing or mass transit tickets. As the specific location of the dual interface antenna pads 106a, 106b, 106c, and the dimensions of the finished card can be derived from the ISO 7816 standard, these dimensions will not be discussed here. Other standards can also be used. As will be discussed below, different antenna pad designs and shapes may also be used to accommodate multiple applications on a single antenna inlay 220. It is understood that the specific design illustrated in FIG. 1 is provided by way of example only. The number of antenna concentric rings or windings, and the location of the contact pads 106a, 106b, and 106c may be determined as desired depending on the specific standard being used, or on other design requirements.

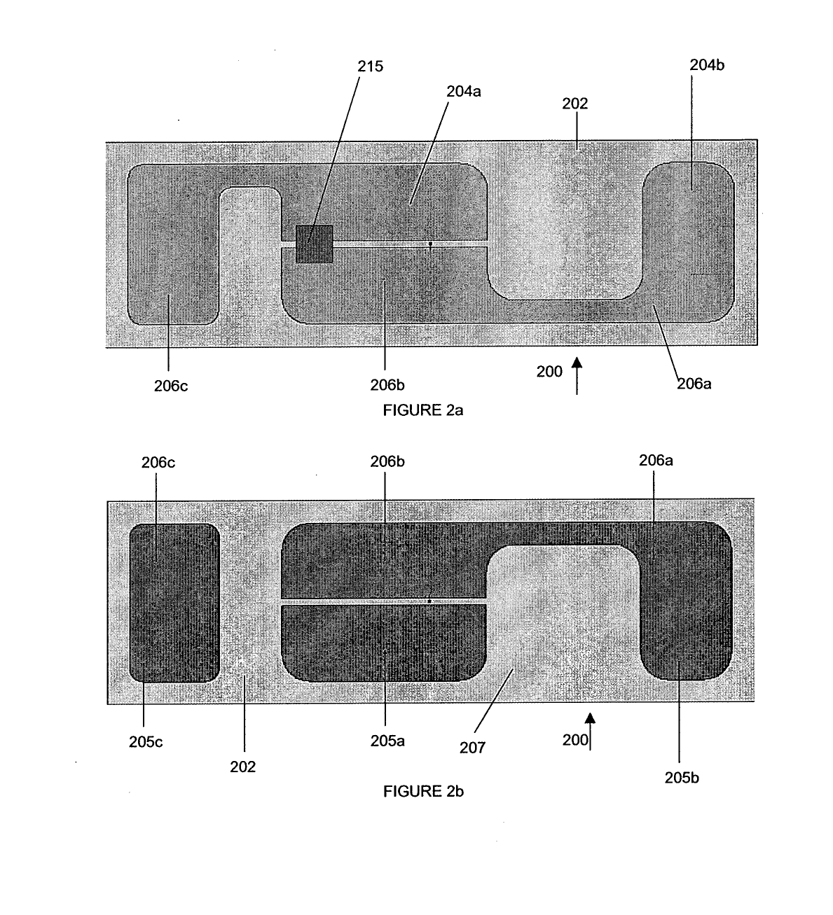

In some embodiments, the polymer PCB 200 may include a chip 215 (FIG. 2a) that allows the finished inlay 220 to be used in contactless smart card applications. In alternate embodiments, the polymer PCB 200 may provide a base for a tower bridge that can be used in dual interface cards. All of the antenna connections 106a, 106b, 106c on the inlay 220, whether for use as a contactless smart card, or a dual interface card, are thus provided on a single antenna singlet 102. Examples of both of these embodiments are provided below with reference to FIGS. 2a-5e.

These antenna singlets 102 provide a portion of the electronic layer that is a base for a smart card. Initially, the plastic sheet 104 is laminated with, for example, an aluminium or copper foil. Other metals may also be used. The laminating process uses a thin layer (3-5 micron) of adhesive to bond the aluminium or copper foil to the sheet 104. The plastic sheet 104 can have thickness ranging from 30 to 200 microns. Similarly, the metal foil can have a thickness ranging from 9 to 70 microns.

Depending on the specific application, the number of windings for the antenna 103, the width of the antenna tracks, and the gap distance between the tracks, may vary. In the embodiment shown, 3 windings are used with a track width of 0.3 mm and a gap of 0.3 mm. In alternate embodiments, the number of winding may vary from about 3 to about 7, the track width may vary from about 0.2 mm to about 1.2 mm, and the gap distance may vary from about 0.2 mm to about 1.2 mm.

The plastic sheet 105 can be, by way of example and not limitation, polyvinylchloride (PVC) or polyethylene terephthalate (PET), ABS, PC, paper, Polythene coated paper, or copolymers of PVC/ABS, PVC/PC, PVC/PET. It is understood that any type of flexible plastic sheeting, or even natural or synthetic paper and pulp products, that are capable of receiving the foil laminate can be used in embodiments of the present invention.

The antenna 103 normally includes several concentric loops or windings to provide adequate reception and transmission capability. The antenna 103 can be typically prepared on the top side 105 of the plastic sheet 104 by etching away the unwanted aluminium or copper and laminating. The aluminium or copper foil laminated on the PET or PVC sheet 104 can be etched using a resist ink layer as a mask to form a circuit pattern layer. Thereafter, the resist ink layer is removed. In alternate embodiments, similar steps can be performed to produce the bridge (not shown) on the underside of the antenna singlet 102. This process is known to those of skill in the art and will not be described in detail here.

In the embodiment shown in FIG. 1, the etching process produces the antenna 103 and contact pads 106a, 106b, 106c on the top side 105. The etching process allows the contact pads 106a, 106b, 106c to be larger than corresponding contacts that use copper wire as the antenna, to facilitate the connection of different types of micro-modules (discussed in detail below). The contact pads 106a, 106b, and 106c may have irregular shapes to facilitate these connections.

The antennas 103 thus produced may be of any desired design, depending on the application. Significantly, the antennas 103 can be designed to facilitate the use of high frequency (13.56 MHz) or ultra high frequency (860-965 MHz) chip systems. The methods used to design antennas for smart cards are known in the art. One example of design software that is available to determine specific antenna characteristics, such as the track width of the aluminium or copper, the long side and the short side gap width, is software known as IE3D, by Zeland software. It is understood that many other programs are also available for custom designing antennas for specific applications for use in smart cards.

Rolls or sheets of antenna singlets 102 (see FIGS. 5b-5d), having specific custom antenna designs, and/or various roll patterns, can be purchased custom manufactured from many known sources. By way of example and not limitation, these rolls or sheets can have from 1 to 5 antenna singlets 103 in a row, with various spacings provided between the singlets 103 depending on the specific application of the finished inlay 220.

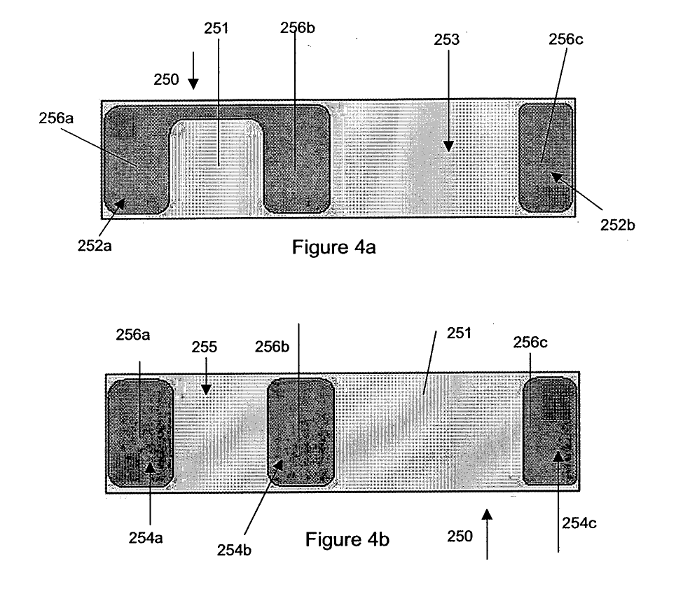

According to one embodiment of the present invention, a polymer PCB containing a chip can be connected to the antenna singlets 102 to produce the smart card inlay 220. In order to provide for the exact dimensional tolerances for the inlays 220, care must be taken in the design of the polymer PCB. FIGS. 2a and 2b illustrate a top and bottom view, respectively, of a polymer PCB, designated generally as reference numeral 200, according to one embodiment of the present invention. Depending on the type of PCB, and the specific application, different cross sectional dimensions may be required. In the embodiment illustrated in FIGS. 2a and 2b, the polymer PCB 200 is made with aluminum foil on both sides using an etching process similar to the aluminum antenna etching process described above. Other materials, such as copper, can also be used. When producing inlays 220 for use in dual interface applications, the polymer PCB 200 can also be known as a tower bridge. This is discussed in more detail below with reference to FIGS. 4a-5b.

In FIG. 2a, the polymer PCB 200 includes a preformed PET base tape 202 with a layer of aluminum on the top and bottom, respectively. It is understood that Polyimide (Kapton), or other plastics, can also be used for the base tape 202, and that other metals, such as copper can also be used. The polymer PCB 200 can include a first metallized area 204a and a second metallized area 204b. To produce a polymer PCB to be used in contactless applications, a chip 215 joining the first metallized area 204a to the second metallized area 204b can be placed on the base tape 202 using, for example, a flip chip bonding process known to those of skill in the art.

High heat resistant grade PET and/or Polyimide prevents the polymer PCB from melting and causing possible short circuits during the lamination process. Hence, it is not necessary to provide by-pass with a plate-through connection to join the open ends of the antenna. However, the presence of the PET or Polyimide layer may require longer ultrasonic bonding times to rub away the polymer layer. The use of a double-sided metallization layer reduces the ultrasonic bonding time to about 1 second. While double-sided polymer PCB is more expensive than single sided, given the relatively small size of the polymer PCB, the incremental cost is negligible. The ultrasonic bonding process is described below with reference to FIGS. 3a-3c.

To produce a dual interface inlay, the base tape 202 can be bonded to the antenna singlet 102 without a chip 215. Additional preparation is then required. This will be discussed below with reference to FIGS. 4a-8c.

In FIG. 2b, a bottom side 207 of the polymer PCB 200 may also include a first metallized area 205a, a second metallized area 205b, and a third metallized area 205c. The metallized areas 204, 205 on the top and bottom of the polymer PCB 200 provide a first bond point 206a, a second bond point 206b, and a third bond point 206c for connecting to corresponding points on the antenna 103 of the antenna singlet 102. The polymer PCB 200 is connected to the antenna singlet 102 in a precise location across the contact pads 106a, 106b, 106c. Bonds are formed between bond points 206a, 206b and 206c on the base tape 202, and the antenna pads 106a, 106b, 106c, on the antenna singlet 102, respectively. Advantageously, this allows the antenna 103 to be connected on both ends, while at the same time the polymer PCB flip chip module 200 is being connected to the antenna 103. The assembled inlay 220 can be used to produce either dual interface or contactless cards. The precise location of the contact pads 106 can be determined by the specific application and/or by international or other standards. One example of such a standard is the ISO 7816 specification.

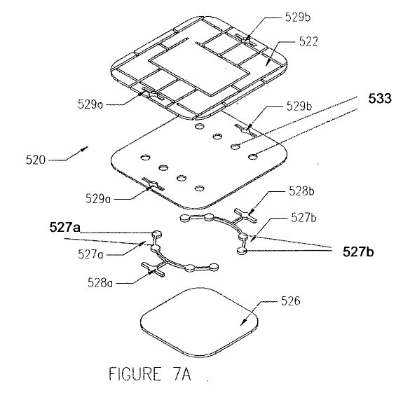

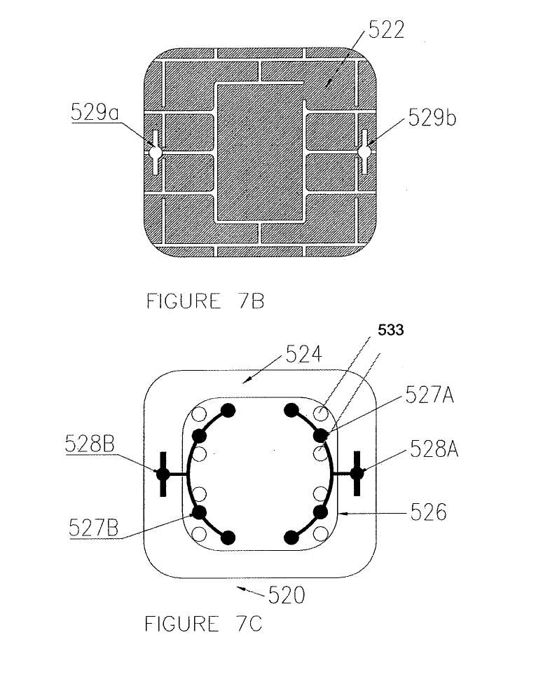

In the embodiment shown in FIG. 1, one end of the antenna 103 is located on an inside of the loop, while the other end of the antenna 103 is located on an outside of the loop. The pads 106a and 106c provide an open connection between the two ends of the antenna 103. Using the polymer PCB 200, ultrasonic bonding between the bond points 206a, 206b, 206c and the antenna pads 106a, 106b, 106c both closes the open connection of the antenna, and connects the chip 215 to the antenna in the case of contactless cards. The first and second ultrasonic bonds close the open antenna connection when the polymer PCB pad 206a is connected to the etched antenna pad 106a and the polymer PCB pad 206c is connected to the etched antenna pad 106c. The third ultrasonic bond connects the dual interface module RF pad 528a to polymer PCB pad 206a and dual interface module RF pad 528b to polymer PCB pad 206b when it comes to producing dual interface inlays. (see FIGS. 7a to 7c)

The following discussion applies to the preparation of a polymer PCB 200 using double sided aluminum tape 202. It is understood that similar preparatory steps can be taken when using double sided copper tape. Since the purpose of the dual interface module is to function as a “single chip” to perform both the contact and contact-less transactions within the same chip, the connection of the antenna 103 to a dual interface module 520 (FIGS. 7a-7c) requires the aluminum or copper tape 202 to function as a tower-bridge to compensate for plastic shrinkage after hot lamination. Matching the thickness of the dual interface module 520 to the card body containing the inlay (etched antenna) can be better achieved by using the polymer PCB 200 as the “flexible bump” or “tower bridge”, since the plating thickness of the polymer PCB 200 is easily customizable or changeable.

If the object is to make a dual interface inlay 220, then the copper-PET-copper or aluminium-PET-aluminium strip 202 will not need to have a chip attached (that is to say, no flip chip bonding is necessary). In this case, the polymer PCB 200 is ready for ultrasonic bonding to the antenna 103. If the object is to produce an inlay 220 for use in contactless applications, then chips have to be flip chip bonded to the polymer PCB 200. In some embodiments, the polymer PCB 200 can be provided with the chip 215 during a pre-production process. The process of flip chip bonding of various types of chips to a polymer strap is known in the art. FIG. 2a shows the polymer PCB 200 with a chip already attached. The process of ultrasonically bonding the polymer PCB to the antenna singlet 102 is described below with reference to FIGS. 3a-3e.

The production of an inlay 220 for contact-less applications using an etched aluminum antenna 103 in embodiments of the present invention can also be accomplished by mounting third party polymer PCB modules containing a chip directly on the antenna 103. By way of example and not limitation, FCP3 (NXP, Holland), NSL-1 (Nedcard, Holland), and other polymer PCB modules can be used.

Work has also been carried out for non Polymer PCB based modules. Lead frame based modules, such as MOA2, MOA4, MOB4, MOB6, MCC2, MCC8, CID pak, Cubit, IOA2, EOA2, EOA8, EOA9, NOA2, NOA3 etc. can also be used to connect to the etched aluminum antenna. In order to accommodate these various micromodules, the terminal pads 106a, 106b, 106c can be designed having varying geometric shapes, such as, but not limited to, a stair-step or other pattern.

In other words, using etched aluminium as the antenna 103, a wide range of materials such as leadframes, polymers, or metallized strips can be strapped. Once the polymer PCB 200 is attached to the antenna contact pads 106 on the antenna singlet 102, the completed inlay 220 can then be used to produce combi cards, contactless smart cards, or dual interface cards, after the addition of top sheets, with hot or cold lamination.

Contactless micromodules have traditionally been attached to the copper wire antenna using a variety of techniques, such as soldering, crimping, adhesive bonding using conductive adhesives, and thermo-compression bonding (also called micro-welding). Thermo compression bonding is currently the most widely used technique. However, it can be difficult to apply this technique for polymer PCBs, since there is a layer of polymeric material that may inhibit good electrical contact.

In a preferred embodiment, the polymer PCB 200, with or without a chip attached, is connected to the antenna singlet 102 using ultrasonic bonding. FIG. 3a illustrates a cross-sectional view, designated generally as reference numeral 300, of an antenna singlet 102, a polymer PCB 200 containing a chip 215, and portions of an ultrasonic bonder, prior to ultrasonic bonding to produce an inlay 220. FIG. 3b illustrates the inlay 220 of FIG. 3a after ultrasonic bonding has been performed. FIG. 3e illustrates a perspective view of one embodiment of an antenna inlay 220. Ultrasonic bonding provides an electrical and mechanical connection between the antenna singlet 102 and the polymer PCB 200 to produce the inlays 220. This connection is illustrated graphically in FIG. 3b as points 107a, 107b, and 107c. While FIG. 3a illustrates the bonding process for a polymer PCB 200 containing a chip 215, it is understood that a similar process can be used for polymer PCBs 200 that do not contain a chip. This is discussed in more detail with reference to FIGS. 4a-5b below. The inlays 220 containing polymer PCBs 200 without chips can be used to produce dual interface smart cards. The process of producing dual interface smart cards is discussed below with reference to FIGS. 5-7.

To ultrasonically bond the polymer PCB 200 to the antenna singlet 102, ultrasonic horns 302a, 302b, 302c and anvils 304a, 304b, 304c of a desired pattern are required to bring about a molecular inter-diffusion of the metallic surfaces of the bond pads 206a, 206b, 206c of the polymer PCB 200 and contact pads 106a, 106b, 106c of the antenna 103 on the antenna singlet 102. The spacing between the horns 302a, 302b, 302c can be determined by the particular application. For example, in the embodiment illustrated in FIG. 3a, the spacing between horns 302c, 302b is about 4.8 mm, and the spacing between horns 302b, 302c is about 10.9 mm. It is understood that many other spacings can also be used as desired.

Employing vibration, force and time, an ultrasonic bonder forms a weld by pressing the parts to be joined together and scrubbing them against one another to break up and disperse the surface oxides and contaminates. The resultant clean base metal surfaces are held tightly together. Crystal boundaries are brought within an atomic distance of one another, allowing the strong attraction of atoms across the interface to create a metallurgical bond, without reaching the melt temperature of the metals being joined.

Typically, an ultrasonic bonding procedure begins with the substrate (antenna singlet 102) being placed on a flat bed. The substrate may be held in place by vacuum. The polymer PCB 200, with or without a chip 215, is then fixed on the antenna singlet 102 using both vacuum pressure and the specific ultrasonic bonding horn 302. By employing vibration, force and time, an electrical and mechanical connection is then formed using the horn 302 and the anvil 304. Co-planarity between the flip chip module 200 and the antenna singlet 102 is carefully adjusted. When ultrasonic power is applied, the polymer PCB 200 and horn 302 vibrate along a horizontal setting direction. Due to relative movement between a first metallic surface (bond pads 206a, b, c) of the polymer PCB 200 and a second metallic surface of the antenna pads 106a, 106b, 106c, friction and heat break up the oxides and disperse the surface oxides and contaminants. This results in micro-welding between them to produce the assembled inlay 220.

One embodiment of a method for producing an inlay 220, designated generally as reference numeral 350, is illustrated in FIG. 3c. The method 350 can includes a first step of providing an inlay substrate having an antenna thereon, the antenna having at least two terminal pads 106a, 106b, as illustrated with reference numeral 352. The method 350 can also include steps for providing a polymer PCB 200, 250 capable of making an electrical connection between the at least two terminal pads 106a, 106b, as illustrated with reference numeral 354, and bonding the polymer PCB 200, 250 to each of the terminal pads 106a, 106b such that the terminal pads 106a, 106b and polymer PCB 200, 250 are positioned to allow the inlay 220 to be used in a desired smart card application, the application selected from a group consisting of a contact smart card, a ticket, a secured document, a contactless smart card, a combi smart card, and a dual interface smart card. Additional steps are discussed below with reference to FIGS. 4a-8c. The bonding step discussed above may include ultrasonically bonding the polymer PCB to the terminal pads.

FIG. 3d illustrates a preferred embodiment of the horns 302. The horn 302 can have a pad 320, a pitch angle 322, and a spacing distance 324. When performing ultrasonic bonding, the horn pad size, the pitch, the horn and anvil pattern, and the number of bond pads per total bondable area, can affect the quality of the bonding process. The bonding force (pressure, measured in kPa), amplitude (μm), ultrasonic power (joules) and bonding time (seconds) are also major factors. In the embodiment illustrated in FIG. 3b, the pad size 320 can be about 0.25 mm by 0.25 mm, the spacing distance 324 can be about 0.5 mm, and the pitch angle 322 can be about 90 degrees. While the overall shape of the embodiment of horn 3b shown is round, it is understood that other shapes may also be used. Similarly, the size of the pad 320, the pitch angle 322, and the spacing 324 may vary.

In one embodiment, a bonding force of approximately 140 kPa, having an amplitude of 45 microns, and 100 joules of power was applied for approximately 1 second to an antenna singlet 102 having an aluminium layer of 30 microns on a PET substrate of 50 microns. It is understood that a great many other combinations of the various factors can also be used to produce an effective ultrasonic bond between the antenna singlet and the polymer PCB 200. Once the bonding is completed, the bonded structure can be tested to ensure a good electrical and mechanical connection. For example, an in-line functional tester capable of testing to some standard can be provided. The standard can be, by way of example and not limitation, ISO 14443 Type A, ISO 14443 Type B, ISO 15693, UHF ISO 18000-6, etc. Readers can be positioned at the end of the production line to track the interconnection based on accumulated yields. If the yield goes below a threshold value, such as 99%, the production can be stopped, and the horn 302 can be examined for wear and tear. The alignment of the polymer PCB 200 and/or other factors may also be checked. Many other techniques for performing such tests are well known in the art.

FIGS. 4a and 4b illustrate a top and bottom view, respectively, of an alternate embodiment of a polymer PCB, designated generally as reference numeral 250, that can be used with the antenna singlet 102 to produce an inlay 220 for use in dual interface applications. The polymer PCB 250 includes a preformed PET base tape 251 with a layer of copper or aluminum 252a, 252b on a top surface 253. Similarly, a layer of copper or aluminum 254a, 254b, and 254c is found on a bottom surface 255. It is understood that PVC, or other plastics, can also be used. Portions of the top copper or aluminum layers 252a, 252b, and bottom copper or aluminum layers 254a, 254b, and 254c provide corresponding bond points 256a, 256b, 256c for attaching to the antenna pads 106a, 106b, 106c of the antenna singlet 102. The process of bonding the polymer PCB 200, 250, was discussed above with reference to FIGS. 3a to 3d.

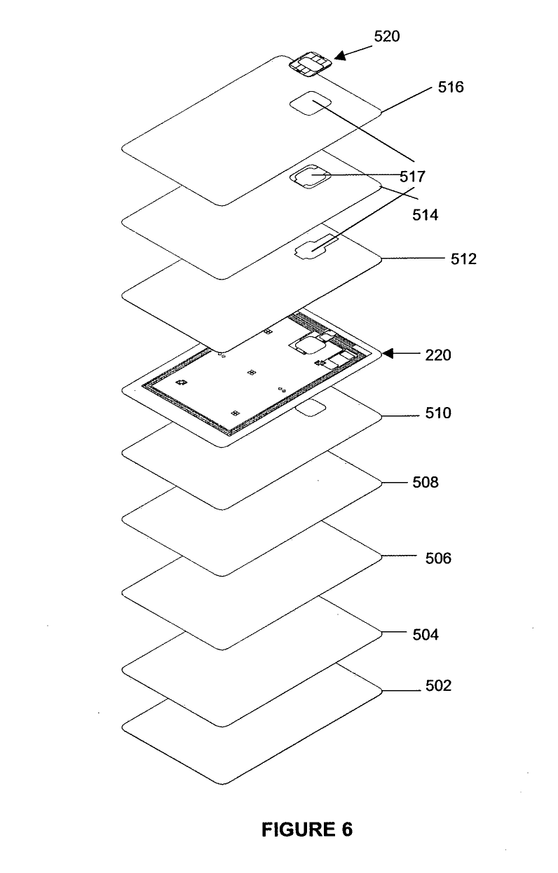

The total thickness of the polymer PCB 250 when functioning as a tower bridge should be large enough to compensate for the card construction and alignment shortfall between the dual interface module and the surface-milled antenna. The thickness should also take into account the amount of expected plastic shrinkage after lamination. The overlays will be discussed below with reference to FIG. 6. Thus, the polymer PCB 250, which can be used as a tower bridge, should have a thickness ranging from 120-180 microns. This thickness can be achieved using, for example, 38 micron PET sandwiched by two layers of aluminum of 35-70 microns on each side. In a preferred embodiment, the thickness of the polymer PCB 250 should be 38 microns PET, 50 microns aluminum on each side of PET, totaling about 150 microns (including 5 microns for each of the adhesive layers between the two metal layers and the PET).

For large scale manufacturing purposes, sheets containing a plurality of antenna singlets 102 can be produced in various configurations. FIGS. 5b-5d illustrate several examples of a sheet 101 containing a plurality of assembled inlays 220 that are ready to be used in smart card applications. FIG. 5b shows three inlays 220 across prepared according to the ID-1 standard. FIG. 5c illustrates a plurality of inlays 220 according to the ID-2 standard, and FIG. 5d illustrates a plurality of inlays 220 arranged for the production of passports or other documents according to the ID-3 standard.

Similarly, the polymer PCBs 200, 250, with or without a chip 215 bonded to them, can be produced in large rolls, suitable for large-scale manufacturing. The polymer PCBs 200 can be connected to the antenna singlets 102 while both are in roll form, and a high speed in-line machine can be equipped with a cut and dispense unit to mount the polymer PCBs 200, 250 and strap them onto a continuous roll of antenna singlets 102 on a flat bed to effect the ultrasonic bonding process. The resulting smart card inlays 220 can then be separated into inlay sheet sizes of 4×6 singlet or 3×8 singlet configurations. Other configurations are also possible depending on the specific laminator used.

In order to make a contactless card, the completed inlays 220, with the flip chip bonded polymer PCB 200 now connected to the antenna pads 106a, 106b, 106c may then be subjected to one or more pre-laminating or laminating steps to produce a semi finished product for easy transportation. For example, after the polymer PCBs 200 are ultrasonically bonded to the terminal pads 106a, 106b, 106c of the aluminium antenna 103, the inlays may be cut into sheet sizes, most commonly including 3×8 singlets, 4×6 singlets, and/or other sizes as desired.

FIG. 5e illustrates one embodiment of a pre-laminated inlay of FIG. 3d, designated generally as reference numeral 270. The pre-laminated inlay 270 can include a first top sheet 272, an additional sheet 274, a final top sheet 276, and a bottom sheet 278. These top sheets 272, 274, 276, can be added to the inlay 220 to produce the pre-laminated inlay 270. In some embodiments, the top sheets 272, 274, may include recess windows so that the chip 215 resides within the recess window to provide “zero pressure” load sheltering. The first top sheet 272 is thus illustrated having a recess window 273, while the additional sheet 274 includes a recess window 275.

Alternately, one or more of the top sheets 272, 274 can be chosen from a material with a lower vicat softening point than the support layer 104. The vicat softening point is defined by industry standard for various polymer materials that do not have a definite melting point. Hot Lamination is a way of bonding two or more layers or plastic sheets together under increased temperature and pressure without using adhesives. Temperature and pressure have opposite effects on lamination quality. The temperature needs to be high enough to allow the layers to melt together. However, due to temperature and pressure, the films (hence the antenna) may begin to flow resulting in sheet (hence antenna) distortion. The use of a lower vicat softening point material in the top sheet 272, for example, allows the sheet 272 to soften and become “molten” at a relatively low temperature (e.g. 60 degrees centigrade) during the pre-heating cycle. This allows the sheet 272 to begin to embrace and embed 75% of the etched aluminum antenna 103 prior to the exertion of any pressure on the inlay 220. The addition of such a low vicat softening material greatly enhances the surface evenness and the structural/mechanical durability of the antenna 103. Consequently, by using a low vicat plastic sheet 272 to cover the inlay 220, and including a window 273 for the polymer PCB 200, it is possible to reduce the shift in operating frequency by preventing any distortion of the etched antenna tracks due to shifts in the gap width during lamination. The goal is to maintain the antenna capacitance value, which is dependent on the track width and gap width of the etched antenna, before and after lamination. If there is any change in the track width (necking) and the gap width of the antenna during the lamination process, the Q factor may change, the read distance may deviate (due to stray capacitance changes) and the etched antenna may become crooked or in a worst case, actually break.

For the embodiment illustrated in FIG. 5e, the first top sheet 272 may have a thickness of about 40 microns, the additional sheet 274 may have a thickness of about 150 microns, and each of the final top sheet 276 and bottom sheet 278 may have a thickness of about 40 microns. It is understood that other thicknesses may be used depending on the specific components being used.

In some embodiments, in order to create an ISO 15457 TFC.1 pre-laminated inlay, the thickness of the pre-laminated ticket inlay 270 for tele-ticketing should be about 280 microns+/−40 microns. Similarly, to create an ISO 7816/7810 ID-1 pre-laminated inlay, the thickness of the pre-laminated card inlay 270 should be about 400 microns+/−40 microns. For ISO 15457 TFC.1 tickets, the thickness of the finished product 270 should be about 360 microns+/−40 microns. For ISO 7816/7810 ID-1 cards, the thickness of the card should be about 760+/−40 microns.

In one embodiment, to further pre-laminate the inlay 220, a reel-to-reel top sheet, such as a PVC film of 100 microns, can be stacked onto the surface of the etched body of aluminium foil and the PET resin film in a reel-to-reel process with a single row of ID-2 sized antennas. This top sheet can have a recess window punched out so that the chip module resides within this recess for “zero” pressure load sheltering. Additionally, an adhesive-backed security printed top sheet and overlay sheet can go over the antenna rolls to produce, for example, an electronic visa page. This allows electronic visas to be produced in high volumes. Many other applications can also use similar techniques to provide for a large volume throughput.

In an alternate embodiment, an ID-3 size etched aluminum inlay 220 can be integrated into both the front and the back cover or holder page to produce a passport. The etched antenna 103 on the passport inlays can be optimized and customized along the edge of the passport page. Epoxy encapsulated modules such as MOB4 or MOB6 are better suited for long life cycle usage. The connection of MOB4 and MOB6 modules to the antenna pads can also be accomplished using the ultrasonic technique described earlier.

Precise positioning of the polymer PCB 200, 250 onto the antenna singlet 102 allows the inlays 220 to be used in multiple applications. If, instead of using the inlays 220 for making contact-less cards, a polymer PCB 200, 250 is used to act as a bridge between the antenna terminal pads 106a, 106b, 106c and a dual interface module, a dual interface card can be produced. In this embodiment, the polymer PCB 200, 250 can be attached to the antenna pads 106a, 106b 106c as discussed above. Whether copper or aluminium is used, in order to form a reliable connection between the etched aluminium antenna pads 106a, 106b, 106c and the polymer PCB 200, 250, it is necessary to break the aluminium oxide layer. This is true regardless of whether the process is used to bond aluminium to aluminium, or copper to aluminium. The ultrasonic bonding process discussed above with reference to FIG. 3a achieves this functionality. A portion of the polymer PCB 200, 250 can then be milled away to provide contact leads for a dual interface module or a contact module. This process is described below.

In order to produce a dual interface card, it is necessary to understand the construction of the entire card, and the various layers involved. FIG. 6 illustrates an exploded perspective view of one example embodiment of a dual interface card, designated generally as reference numeral 500. It is understood that this embodiment is provided for the purposes of illustration only. The dual interface inlay 220 and the various methods described for producing smart cards can be applied to any type of smart card, having fewer or more layers than those illustrated in the example embodiments. The exploded view of the dual interface card 500 shown in FIG. 6 illustrates the card 500 after the milling process (discussed below) has been accomplished.

The dual interface card 500 can include an upper overlay sheet 502 having a thickness of approximately 40 microns, an upper print sheet 504 having a thickness of approximately 210 microns, a top overlay sheet 510 having a thickness of approximately 40 microns, the inlay sheet 220 having a thickness of approximately 100 microns, a bottom overlay sheet 512 having a thickness of approximately 40 microns, two additional sheet 508 and 506 of 100 micron each, a lower print sheet 514 having a thickness of approximately 210 microns, and a lower overlay sheet 516 having a thickness of approximately 40 microns. The top overlay sheet 510 and bottom sheet 512 may have been attached to the inlay sheet 220 during the pre-lamination phase discussed above. The dimensions discussed above are for the purpose of illustration only. It is understood that more or fewer sheet, or sheets having different thicknesses, can also be used. It is also understood that the cards can be singulated (by punching from the laminated sheets) and conformed to the ISO 7816/7810 standard thickness of 0.76+/−40 microns including the top/bottom printed and overlay sheets; prior to the insertion of the dual interface modules 520.

A dual interface module 520 can be mounted on the dual interface card 500. FIG. 7a illustrates an exploded perspective view of one embodiment of a dual interface module 520. FIGS. 7b and 7c illustrate a top and bottom view, respectively, of the dual interface module 520. The dual interface module 520 can include an upper gold-nickel plated copper layer 522, a middle Epoxy Glass layer 524 (made from, for example, an epoxy laminate), and a lower layer 526 providing epoxy encapsulation to protect the chip. The bottom side of the middle layer 524 may include a layer of copper or other metal. The gold-nickel plated copper layer 522 can be etched to produce suitable circuitry for the contact chip Input/Output pin connections. Similarly, a pair of double sided metallization pads 528a, 528b, and connections 527a, 527b can be etched from the layer of copper on the bottom side of the middle layer 524 to provide RF electrical connections between the dual interface module 520 and the antenna 103 in the inlay 220.

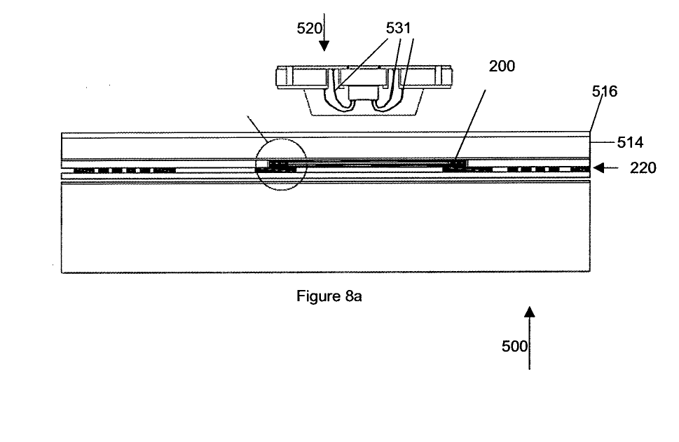

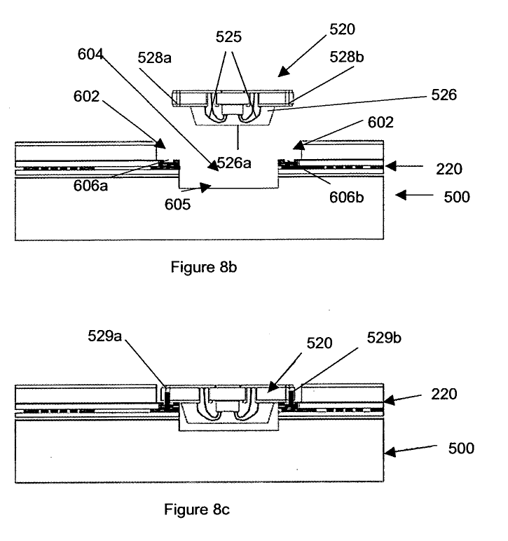

Typical dual interface microprocessor chips have 6 input/out pins (namely, voltage supply, reset signal, Clock signal, ground, Programming voltage, and Data Input/Output). The remaining two contacts are reserved within the ISO/IEC 1/SC17 standard for future use. These 6 pins are connected to the respective ISO 7816/7810 specification locations via holes 533 in the Epoxy Glass tape to the respective top metallization layer 522. The RF part of the dual interface chip has only two pins. These two pins can be connected to the nearest ring pad 527a, 527b along the circular ring track depending on which is the shortest critical path between the chip and the metallization pads 528a and 528b. The lower layer 526 may encapsulate a plurality of wires 531 (FIG. 8a) used to make various electrical connections, such as the connection between the ring pads 527a, 527b and the module 520.

Each of the layers 522, 524 may have a pair of corresponding windows 529a, 529b that facilitate access for an ultrasonic bond head 302 to ultrasonically bond the metallization pads 528a, 528b to corresponding portions of the tower bridge on the inlay 220. These windows 529a, 529b may be placed anywhere on the module that is outside an area 531 that contains the 6 ISO 7816 contact module electrical connections and chip within the module 520.

Any type of dual interface module 520 can be used to construct the dual interface card 500 according to the embodiments. By way of example and not limitation, the modules can be any one of a D7 or D8 module (ST Microelectronics), an M8.4 module (Infineon), or other modules known to those of skill in the art. When using a M8.4 module, the upper layer can have dimensions of 13 by 11.8 mm. The module 520 can have a thickness of about 0.58 mm. The lower layer 526 can be approximately 8.6 by 8.6 mm, with a thickness of about 0.35 mm. In large scale production, the modules 520 can be delivered on 35 mm tape rolls, with a matrix of 2 modules per row, and a gap between modules of about 14.25 mm.

In order to connect the dual interface module 520 to the dual interface card 500, several preparatory steps should be taken. FIGS. 8a-8c illustrate the process. FIG. 8a shows one embodiment of a laminated dual interface card 500 and a dual interface module 520 before any preparatory steps are taken. FIG. 8b illustrates the dual interface card 500 prepared to receive the dual interface module 520. FIG. 8c illustrates the assembled dual interface card 500 with the dual interface module 520 installed. Note that the Figures are not drawn to scale, but are provided merely to illustrate the milling process.

FIG. 8a illustrates the dual interface card 500 containing the inlay 220 having a polymer PCB 200, 250 attached. In order to connect the dual interface module 520 to the card 500, a portion of the card 500 must be milled to expose a portion of the polymer PCB 200, 250, which is then used as a tower bridge. The tower bridge functions as strap leads to provide an electrical connection between the dual interface module 520 and the antenna 103. In one embodiment, when preparing the inlay 220 with the polymer PCB 250 for use in a dual interface card 500, a tower bridge having an aluminum foil surface of at least 35 microns is preferred. With reference to FIG. 8b, two separate cavities can be precisely milled out of the dual interface card 500. A first cavity 602 that corresponds to an outer perimeter of the module 520 is milled to expose the tower bridge 200. A second cavity 604 is precisely milled to accommodate the lower layer 526 of the dual interface module 520. When preparing the second cavity 604, the center portion of the tower bridge 200 is also milled away, leaving corresponding contact leads 200a, 200b that are still electrically connected to the antenna 103 as described above. Additionally, in a preferred embodiment, a 5-10 micron portion of the contact leads 200a, 200b can also be milled away, leaving slight grooves 606a, 606b in the contact leads 200a, 200b, respectively. These grooves 606a, 606b expose a portion of the contact leads 200a, 200b to ensure a good electrical connection between the contact leads 200a, 200b, which can be milled to provide exposed leads for an ultrasonic bond that makes an electrical connection between the metallization pads 528a, 528b and the contact leads 200a, 200b, respectively. The grooves 606a, 606b can be formed with a width and a depth specifically designed to receive the corresponding metallization pads 528a, 528b located on the dual interface module 520.

As described above, the exact size and location of the contact leads 200a, 200b and the metallization pads 528a, 528b are selected to ensure adherence to a desired standard. For example, the ISO 7816-1 physical specifications can be used. Alternately, other specific specifications can be used, depending on specific design considerations for the assembled smart card 500. Examples of other specifications that may be used can include ANSI/ISO/IEC 7816/7810 and ISO 10373.

In order to mechanically attach the chip module 520 to the smart card 500 body, a non-conductive adhesive can be applied to a bottom 605 of the second cavity 604 and/or to a lower surface 526a of the lower layer 526 of the dual interface module 520. The non-conductive adhesive can be, by way of example and not limitation, cyanocrylate, an epoxy, a light sensitive epoxy and an acrylate. Additionally, a non-conductive adhesive or heat curable Tesa tape can be applied to the shelf 602, but not the antenna contact leads 200a, 200b, and elsewhere within the second cavity 604 in order to mechanically secure the chip module 520 to the smart card body 500. In some embodiments, a hot melt tape may be applied to the lower surface 526a of the lower layer 526. The hot melt tape may have one or more holes that can accommodate the use of the non-conductive adhesive described above.

In large scale production processes, the dual interface module 520 can be fixed on a reel of tape (not shown) to facilitate rapid assembly of the smart cards 500. In this process, the dual interface module 520 can then be removed from the reel of tape and flipped or inserted to align its metallization pads 528a, 528b pads with the antenna contact leads 200a, 200b, respectively. The dual interface module 520 is placed into the first and second cavities 602, 604 with a small force normal to the substrate surface to finish the assembly. In a preferred embodiment, the total depth of the milled cavities 602, 604 should match the thickness of the dual interface module 520. The detailed requirements of the z-depth position of the module are clearly stipulated in the ISO 7816-1 standard, whereby no point of the contact surface shall be higher than 0.05 mm above or lower than 0.1 mm below the adjacent surface of the card. This allows the top portion of the dual interface module 520 to be within the specification of a corresponding ISO 7816 reader (not shown).

Using a customised ultrasonic horn 302 having a weld lobe of 0.5 to 1 mm in diameter, the ultrasonic horn 302 can reach the metallization pads 528a, 528b via windows 529a, 529b to form an electrical and mechanical connection with the antenna contact leads 256a, 256b. In alternate embodiments, the dual interface module 520 can be handled and attached using techniques of chip handling known to those of skill in the art. FIG. 8c shows a cross-sectional view of the dual interface smart card 500 produced using the steps outlined above. The cavities 529a and 529b may then be closed using a semiconductor grade thermoplastic or thermosetting high temperature hot melt.

Embodiments of the inlays described above provide several advantages over the prior art. The ultrasonic bonding process achieves a plate-through effect for the antenna connection using the polymer PCB. This provides a solid-state connection useful for both contactless, combi, and dual interface smart cards.

Embodiments of the invention produce a contactless inlay using an etched aluminum antenna with a Polymer PCB. By positioning a polymer PCB including a chip module as an umbilical cord (using the polymer PCB as a horizontal bridge), inlays can be produced that function as contactless cards. It is possible to extend the contactless polymer strap anywhere along the vertical axis of the path of the current layout where the second position awaits the polymer PCB strap, thus providing much greater flexibility in determining where the Polymer PCB can be attached to this contactless antenna. By positioning a polymer PCB acting as a dummy strap, a tower bridge may be created using the thicker metal layer on the polymer PCB as vertical bridges. Inlays can then be produced that either function as combination, contact, or dual interface cards. Currently, the industry has enough capacity to build 2 billion contact & dual interface cards. Inlays produced from these embodiments allow existing card manufacturers to use existing equipment to make both contactless and dual interface cards without having to upgrade or otherwise modify the expensive equipment used in manufacturing the cards.

Embodiments of the ISO cards produced using inlays having an etched aluminum antenna are able to withstand up to 20,000 cycles of the ISO 10373 bending and torsion tests. Thus proving wrong the conventional wisdom that predicted that such cards could only perform up to one or a few thousand cycles of the ISO 10373 bending and torsion reliability tests. The cards produced from the embodiments of the inlays also are able to reach communication distances specified for proximity chips, i.e. a minimum of 10 cm for Mifare 1K cards using reader test standards specified in ISO 10373 test methods on ISO 14443 chips.

The use of the 3 layer low vicat softening plastic to sandwich the antenna layer helps to prevent antenna distortion. Furthermore, the use of this plastic strengthens the etched antenna against changes in capacitance which otherwise can occur due to stresses laid upon it by the high Vicat rigid sheets which induces distortion during hot lamination process.

The inlays of the present invention allow for the production of combination, contact, contactless, or dual interface cards using an etched aluminium inlay as a base antenna. This greatly reduces the time required in the manufacturing process, as etched antennas, additional top sheets, and printed (security features or even sticky labels) overlays can be produced in roll form. Because the etched antenna terminals can be patterned in a zigzag, stair-step, or other varying pattern design, it is easy to adapt the embodiments of the inlays to use various industrial micro modules which are commonly used in packaging contact-less and dual interface modules. Additionally, when producing dual interface cards, the process described above provides cards having a reliability that cannot be achieved using conventional copper wire technology.

It is understood that, while one design of an antenna structure was discussed to illustrate the process, any type of antenna structure or design, such as antenna shapes that are circular, rectangular, square, or other odd shapes and sizes, may be used in embodiments of the inlays. The cards can be produced in any size, having any thickness desired by the end user. Similarly, the inlays can be manufactured using a wide variety of chips or modules for use in various smart card applications, such as HF, UHF, and other applications. These inlays can be used in applications that can include but are not limited to, HF ISO 14443 Type A, ISO 14443 Type B, ISO 15693, ISO 18000 UHF or EPC compliant RFID, or any other form factor dual interface or contact-less use such as ISO 7816/7810 (ID-1, ID-2, ID-3) tickets, labels and cards, ISO 15457 TFC.1 tickets, the Calypso standard for transportation, the EPC standard for RFID specifications, and the ICAO 9309 Part-1 recommendation for secure documents.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. An inlay for a smart card, the inlay comprising:
an inlay substrate;
an antenna on the inlay substrate, the antenna having at least two terminal pads; and
a polymer PCB bonded to and making an electrical connection between each of the terminal pads, said polymer PCB comprising a substrate having a layer of aluminum or copper foil attached to at least one of a top side and a bottom side of the substrate;
wherein the terminal pads and polymer PCB are positioned to allow the inlay to be used in a desired smart card application, the application selected from a group consisting of a contact smart card, a contactless smart card, a ticket, a secured document, a combi smart card and a dual interface smart card;
wherein, when the inlay is to be used in a contactless smart card, ticket, secured document or combi smart card, said polymer PCB functions as a carrier for a chip; and
wherein, when the inlay is to be used in a dual interface or contact smart card, end portions of the polymer PCB function as strap leads to connect an embedded chip of the dual interface or contactless smart card to said antenna; and
wherein the chip is electrically coupled to said layer of aluminum or copper foil on one of said top side and said bottom side and said terminal pads, for use in said contactless smart card, said ticket, said secured document, or said combi smart card, and wherein the layer of aluminum or copper foil provides the electrical connection between the terminal pads and the chip or a chip module.

2. The inlay of claim 1, wherein:
the layer of aluminum or copper foil is attached to each of the top side and the bottom side of the substrate;
said chip module is selected from a group consisting of MOA2, MOA4, MOB4, MOB6, MCC2, MCC8, CID, Cubit, IOA2, EOA2, EOA8, EOA9, FCP3 and NSL-1 micromodules; and
said terminal pads are at least 0.25 square millimeters in area.

3. (canceled)

4. (canceled)

5. The inlay of claim 1, or wherein the polymer PCB comprises a substrate having a layer of aluminum or copper foil attached to each of a top side and a bottom side of the substrate for use in producing said dual interface and said contact smart cards, the antenna comprises three terminal pads, and the layers of aluminum or copper foil provide the electrical connection between the terminal pads and a dual interface module.

6. The inlay of claim 5, wherein
the inlay is sandwiched between a plurality of laminated sheets to produce a blank of said dual interface smart card; and
a portion of said plurality of the laminated sheets and said polymer PCB are milled away to produce a cavity, such that a remaining portion of said polymer PCB provides the strap leads that function as a tower bridge for electrically connecting the dual interface module to said antenna to produce said smart card.

7. (canceled)

8. The inlay of claim 6, wherein said dual interface module further comprises a pair of windows to facilitate bonding of said dual interface module to said strap leads; and said inlay further comprises at least one upper layer of low vicat plastic.

9. The inlay of claim 1, wherein said antenna pads and said polymer PCB are positioned accordingly to suit an industry standard, said industry standard selected from a group consisting of an ISO 7816/7810 ID-1, ID-2, and ID-3 standard, an ISO 15457 TFC.1 standard, a Calypso standard for transportation tickets, and an ICAO 9303 Part-1 recommendation;
wherein said inlay functions according to an Interoperability/modulation characteristic standard selected from a group consisting of an ISO 14443 standard, an ISO 15693 standard, and ISO 18000 UHF and EPC compliant RIFD standards; and
wherein the smart card application is further selected from a group consisting of a sticker, a label, a passport, and an anti-counterfeit tag.

10. The inlay of claim 1, wherein said antenna comprises etched aluminum having a thickness of about 9 microns to about 35 microns; a track width of about 100 microns to about 1200 microns, and a gap width of about 100 microns to about 1200 microns; and wherein said substrate comprises a plastic sheet having a thickness ranging from 30 to 200 microns.

11. The inlay of claim 1, wherein
the polymer PCB is bonded to the at least two terminal pads of the antenna using one of soldering, crimping, adhesive bonding using conductive adhesives, thermo-compression bonding, and an ultrasonic bonding process; and
said ultrasonic bonding process uses a horn having at least two pads with a pad size of at least 0.25 mm by 0.25 mm, a spacing distance of about 0.5 mm, and a pitch angle of about 90 degrees.

12. (canceled)

13. (canceled)

14. A method of producing an inlay for a smart card, the method comprising the steps of:
providing an inlay substrate having an antenna thereon, the antenna having at least two terminal pads;
providing a polymer PCB comprising a substrate having a layer of aluminum or copper foil attached to at least one of a top side and a bottom side of the substrate and capable of making an electrical connection between the at least two terminal pads; and
bonding the polymer PCB to each of the terminal pads;
wherein the terminal pads and polymer PCB are positioned to allow the inlay to be used in a desired smart card application, the application selected from a group consisting of a contact smart card, a ticket, a secured document, a contactless smart card, a combi smart card, and a dual interface smart card; and
wherein a chip is electrically coupled to said layer of aluminum or copper foil on one of said top side and said bottom side and said terminal pads, such that said bonding step provides an electrical connection between said antenna and said chip for use in said contactless smart card, said ticket, said secured document, or said combi smart card.

15. The method of claim 14, wherein the layer of aluminum or copper foil is attached to each of the top side and the bottom side of the substrate; and wherein said method further comprises, after said step of providing a said antenna, a step for providing a high speed in-line machine equipped with a cut and dispense unit to mount the polymer PCB and strap said polymer PCB onto a continuous roll of antenna singlets on a flat bed to effect the ultrasonic bonding process.

16. The method of claim 15, wherein:
said chip comprises a micromodule selected from a group consisting of MOA2, MOA4, MOB4, MOB6, MCC2, MCC8, CID, Cubit, IOA2, EOA2, EOA8, EOA9, FCP3 and NSL-1 modules; and wherein said micromodule and antenna are designed to facilitate the use of high frequency or ultra high frequency chip systems; and
said terminal pads are at least 0.25 square millimeters in area.

17. (canceled)

18. The method of claim 14, further comprising:
providing a reel-to-reel top sheet stacked onto a surface of the inlay substrate in a reel-to-reel process, said top sheet having a recess window punched out and positioned such that the chip resides within said recess for “zero” pressure load sheltering;
providing an in-line functional tester to test said bond to ensure a good electrical and mechanical connection;
applying at least one upper layer of low vicat plastic to a top of said inlay, and applying at least one lower layer of low vicat plastic to a bottom of said inlay; and
wherein the polymer PCB comprises a substrate having a layer of aluminum or copper foil attached to each of a top side and a bottom side of the substrate for use in producing said dual interface and said contact smart cards.

19. (canceled)

20. The method of claim 18, further comprising:
laminating at least a first layer of material to a top surface of said inlay;
laminating at least a second layer of material to a bottom surface of said inlay, said first layer, said second layer and said inlay comprising a blank for producing a dual interface smart card;
milling a portion of said first layer and said inlay to remove a portion of said polymer PCB to produce a tower bridge, and to provide a cavity for receiving a dual interface module; and
wherein the smart card application is further selected from a group consisting of a sticker, a label, a passport, and an anti-counterfeit tag.

21. The method of claim 20, further comprising connecting said dual interface module to said blank to produce said dual interface smart card; wherein
said connecting step further comprises:
ultrasonically bonding said dual interface module to said tower bridge to provide an electrical connection to said antenna;
fixing said dual interface module to said blank using a non-conducting adhesive;
said ultrasonic bonding process uses a horn having a pad size of at least 0.25 mm by 0.25 mm, a spacing distance of about 0.5 mm, and a pitch angle of about 90 degrees;
said dual interface module further comprises a pair of windows in a top surface thereof; and
said windows facilitate said ultrasonic bonding process, a soft laser bonding process, a crimping process, a thermo-compression bonding process, or a micro-welder bonding process.

22. (canceled)

23. (canceled)

24. (canceled)

25. (canceled)

26. The method of claim 14, wherein
said two providing steps further comprise positioning said antenna pads and said polymer PCB according to an industry standard, said industry standard selected from a group consisting of an ISO 7816/7810 ID-1, ID-2, and ID-3 standard, an ISO 15457 TFC.1 standard, a Calypso standard for transportation tickets, and an ICAO 9303 Part-1 recommendation; and
said polymer PCB is bonded to said terminal pads using an ultrasonic bonding process.

27. (canceled)
